(19) United States
(12) Patent Application Publication
(10) Pub. No.: US 2009/0310489 A1
(43) Pub. Date: Dec. 17, 2009

(54) METHODS AND APPARATUS USING A SERIAL DATA INTERFACE TO TRANSMIT/RECEIVE DATA CORRESPONDING TO EACH OF A PLURALITY OF LOGICAL DATA STREAMS

(76) Inventor: Andrew M. Bennett, Spokane, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/140,941

(22) Filed: Jun. 17, 2008

(51) Int. Cl. H04L 12/56

(52) U.S. Cl. 370/236

(57) ABSTRACT

Data corresponding to each of a plurality of logical data streams may be transmitted across a serial data interface by 1) staging data for at least some of the logical data streams; 2) determining a data readiness of the data staged for each logical data stream; 3) generating a plurality of messages, each of the messages having a header, and at least some of the messages carrying some of the data, wherein the headers of the messages carrying data identify the logical data stream(s) to which their data pertains; 4) using i) the data readiness of the data staged for each logical data stream, and ii) a priority scheme of the logical data streams, to periodically designate an active one of the logical data streams; and 5) transmitting, via the serial data interface, messages corresponding to the active one of the plurality of logical data streams, but not messages corresponding to other ones of the plurality of logical data streams.

### BACKGROUND

There are two common ways of transmitting data corresponding to each of a plurality of data streams via a data interface. One way uses a parallel address/data bus, with each of the data streams writing to (and reading from) a separate address range. The other way uses a serial bus and a pre-defined interleaving scheme.

One exemplary parallel address/data bus is the cluster bus of the TigerSHARC® processor (offered by Analog Devices, Inc. of Norwood, Mass., USA). A disadvantage of using such a bus is that it consumes a large number input/output (I/O) pins. Furthermore, the same lines are typically used to transmit and received data, making the bus unidirectional at any given point in time (i.e., the bus is half-duplex). The overhead of implementing a large number of I/O paths also tends to encourage sharing of the bus by multiple devices (e.g., a plurality of processors in a “cluster”).

A pre-defined interleaving scheme is advantageous over a parallel address/data bus because it can be implemented using a serial data interface, making it more feasible to implement a bi-directional (i.e., simultaneous transmit/receive) link. However, a disadvantage of a pre-defined interleaving scheme is the fixed relationship between the data transfer rates of each data stream. That is, the pre-defined interleaving of the data streams makes it very difficult (and really not possible) to individually change the data transfer rate of any particular data stream.

### BRIEF DESCRIPTION OF THE DRAWINGS

Illustrative embodiments of the invention are illustrated in the drawings, in which:

FIG. 1 illustrates an exemplary new system for transmitting data over a serial data link;

FIG. 2 illustrate an exemplary method for transmitting, via a serial data interface, data corresponding to each of a plurality of logical data streams;

FIG. 3 illustrates exemplary apparatus for implementing a method such as the method shown in FIG. 2;

FIG. 4 illustrates a first exemplary way of implementing the serial data transmitter shown in FIG. 3;

FIG. 5 illustrates a second exemplary way of implementing the serial data transmitter shown in FIG. 3 or the serial data receiver shown in FIG. 7;

FIG. 6 illustrates an exemplary method for receiving, via a serial data interface, data corresponding to each of a plurality of logical data streams;

FIG. 7 illustrates exemplary apparatus for implementing a method such as the method shown in FIG. 6;

FIG. 8 illustrates an exemplary way of implementing the serial data receiver shown in FIG. 7;

FIG. 9 illustrates an exemplary message structure for messages transmitted/received via the system shown in FIG. 1; and

FIG. 10 illustrates an exemplary header for the message structure shown in FIG. 9.

### DETAILED DESCRIPTION

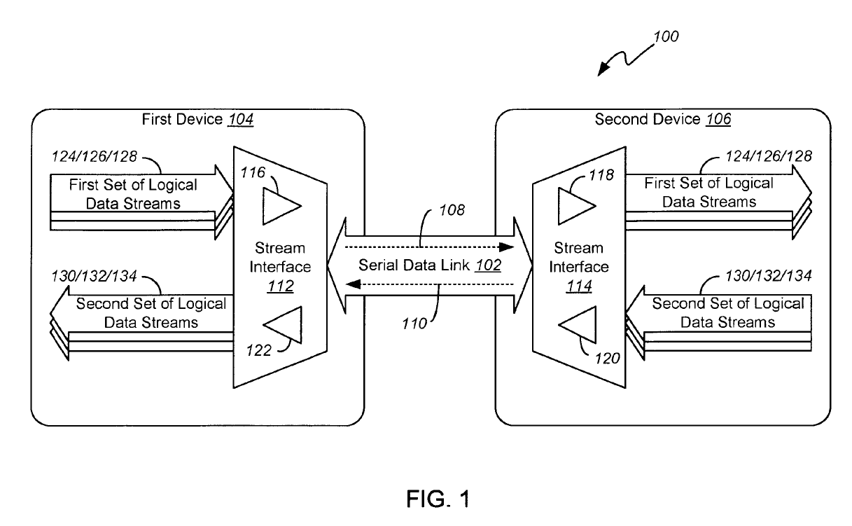

FIG. 1 illustrates an exemplary new system 100 for transmitting data over a serial data link 102. The system 100 comprises first and second devices 104, 106, connected by one or more serial data channels 108, 110 of the serial data link 102. By way of example, each of the devices 104, 106 may be a digital signal processor (DSP), field-programmable gate array (FPGA), programmable logic device (PLD) or application-specific integrated circuit (ASIC).

As shown, the serial data link 102 may comprise a first channel 108 for transmitting serial data from the first device 104 to the second device 106, and a second channel 110 for transmitting serial data from the second device 106 to the first device 104. In some cases, only one of the channels 108, 110 may be provided. In these cases, data transmission may be limited to a single direction; or one of the devices 104, 106 may serve as the arbiter for the serial data link 102.

As also shown in FIG. 1, each of the first and second devices 104, 106 is provided with a stream interface 112, 114 that couples a respective one of the devices 104, 106 to the serial data link 102. Each stream interface 112, 114 may in turn comprise a serial data transmitter 116, 120 and a serial data receiver 118, 122, although in some cases, a stream interface 112, 114 may comprise only a serial data transmitter or a serial data receiver. Each of the serial data transmitters 116, 120 is paired with a corresponding serial data receiver 118, 122 in the other one of the devices 104, 106 (e.g., the serial data transmitter 116 of the first device 104 is paired with the serial data receiver 118 of the second device 106). A first transmitter/receiver pair 116/118 facilitates the transmission of data via the first serial data channel 108; and if provided, a second transmitter/receiver pair 120/122 facilitates the transmission of data via the second serial data channel 110.

As further shown in FIG. 1, each of the transmitter/receiver pairs 116/118, 120/122 uses its respective serial data channel 108, 110 to transmit data corresponding to each of a plurality of logical data streams 124/126/128, 130/132/134. As will be discussed in greater detail herein, an advantage of the system 100 is that data corresponding to different logical data streams 124/126/128, 130/132/134 may be transmitted at different, largely independent, data transfer rates, in accord with a priority scheme of the logical data streams 124/126/128, 130/132/134. In this manner, data corresponding to a plurality of logical data streams 124/126/128, 130/132/134 may be transmitted via a serial data link 102, yet in a way that avoids some of the structure of a pre-defined interleaving scheme.

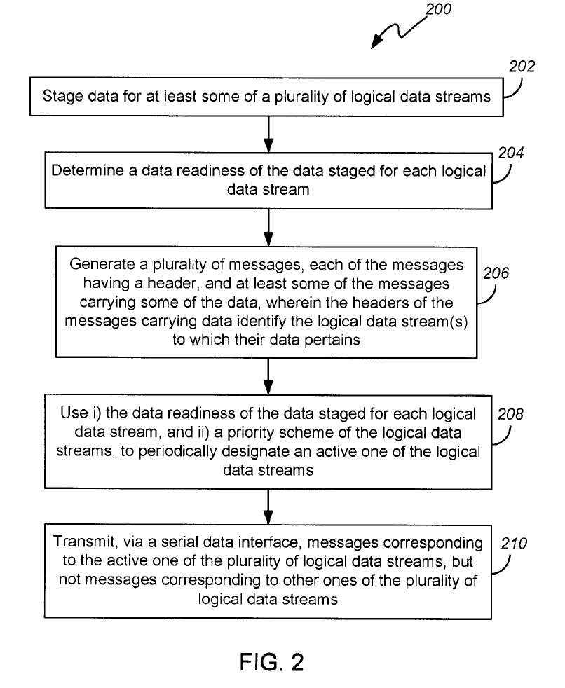

Turning now to FIG. 2, there is shown a method 200 for transmitting data corresponding to each of a plurality of logical data streams. In some embodiments, the method 200 may be implemented by the stream interface (112 or 114) of one of the devices 104, 106 shown in FIG. 1.

The method 200 comprises a step 202 of staging data for at least some of the logical data streams. By way of example, the staging of data may be accomplished using a plurality of first-in first-out (FIFO) or ping-pong buffers, as will be discussed in greater detail later in this description.

At step 204, a “data readiness” of the data staged for each logical data stream is determined. That is, data readiness is determined on a stream-by-stream basis.

At step 206, a plurality of messages is assembled. Each of the messages is provided with a header, and at least some of the messages carry some of the data that has been staged for the logical data streams. For messages that carry data, the headers of the messages identify the logical data stream(s) to which their data pertains.

It is envisioned that, typically, a message will only carry data pertaining to one particular logical data stream. However, a broadcast message, in which the header of the message indicates that data is to be broadcast to multiple ones of the logical data streams, is also contemplated.

Of note, a message that carries data need only carry some of the data that has been staged for a particular logical data stream (although there may be cases where the quantity of a logical data stream's data is small enough that all of the stream's data may be carried in a single message).

At step 208, both i) the data readiness of the data staged for each logical data stream, and ii) a priority scheme of the logical data streams, is used to periodically designate an active one of the logical data streams. Then, at step 210, messages corresponding to the active one of the plurality of logical data streams are transmitted via a serial data interface, while messages corresponding to other ones of the plurality of logical data streams are not transmitted.

Optionally, flow control information may be received via the serial data interface. The flow control information is indicative of a remote receiver's readiness to receive data and may be used as an additional basis for designating the active one of the logical data streams. In this manner, flow control for a particular logical data stream can be regulated by both the transmitting and receiving ends of a serial data link.

Although the steps of the method 200 are shown to have a particular flow, it is noted that the flow is not important, and that various flows are contemplated. In fact, in most cases, all of the method's steps will be performed in parallel.

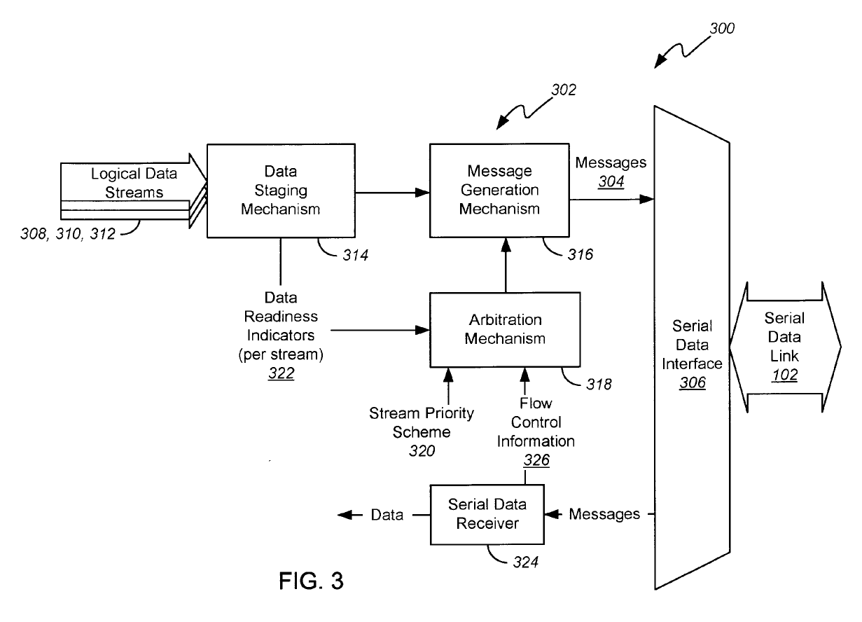

FIG. 3 illustrates exemplary apparatus 300 for implementing a method such as the method 200. As shown, the apparatus 300 comprises a serial data transmitter 302. The serial data transmitter 302 is configured to transmit messages 304 via a serial data interface 306. In particular, the serial data transmitter 302 is configured to 1) transmit messages 304 corresponding to an active one of a plurality of logical data streams 308, 310, 312, and 2) not transmit messages 304 corresponding to other ones of the plurality of logical data streams 308, 310, 312. What is meant by the “active one” of the plurality of logical data streams will become clear shortly.

Looking at the serial data transmitter 302 in more detail, the serial data transmitter 302 comprises a data staging mechanism 314, a message generation mechanism 316, and an arbitration mechanism 318. In some embodiments, these structures may be implemented individually. In other embodiments, the functionality of these structures may be provided by one or more multi-purpose structures.

The data staging mechanism 314 stages data for at least some of the logical data streams 308, 310, 312 and sets a data readiness indicator for the data staged for each logical data stream 308, 310, 312. The data readiness indicator 322 indicates, for example: when the staging mechanism 314 has staged more than a predetermined quantity of data for a particular logical data stream 308, 310, 312, or when an end-of-frame (EOF) indicator has been received for a particular logical data stream 308, 310, 312.

The message generation mechanism 316 assembles (e.g., packetizes) a plurality of messages 304. Each of the messages 304 is assembled with a header, and at least some of the messages carry some of the data staged by the data staging mechanism 314. For messages that carry data, the headers of the messages identify the logical data stream(s) to which their data pertains.

As also shown in FIG. 3, the logical data streams 308, 310, 312 have a priority scheme 320. That is, each of the streams 308, 310, 312 is designated as having a highest priority, a next highest priority, and so on. The arbitration mechanism 318 uses i) the data readiness indicators 322 for the logical data streams 308, 310, 312, and ii) the priority scheme 320 of the logical data streams 308, 310, 312, to periodically designate the active one of the logical data streams 308, 310, 312. For example, the arbitration mechanism 318 may determine which of the logical data streams 308, 310, 312 is active by determining which of the logical data streams 308, 310, 312 are ready to send data, and designating the “ready” stream having the highest priority as the “active” stream. By designating which stream is active on a periodic basis, a lower priority data stream is not able to monopolize the serial data interface 306 when a higher priority data stream is ready to send data. In this manner, a lower latency can be maintained for streams of higher priority. As defined herein, the maximum latency of a particular logical data stream is equal to the largest message size of the other logical data streams. The latency of a logical data stream can therefore be adjusted by limiting the lengths of the messages generated for the others of the logical data streams.

In some embodiments, the apparatus 300 shown in FIG. 3 may further comprise a serial data receiver 324. The serial data receiver 324 may be configured to receive flow control information 326 via the serial data interface 306, the flow control information 326 being indicative of a remote receiver's readiness to receive data. In some cases, the flow control information 326 may indicate the remote receiver's readiness to receive data corresponding to each one of the logical data streams 308, 310, 312. In other cases, the flow control information 326 may indicate the remote receiver's readiness to receive data “as a whole”. Regardless, the flow control information 326 may be used by the arbitration mechanism 318 as an additional basis for designating the active one of the logical data streams 308, 310, 312. In this manner, either the serial data transmitter 302 or a remote receiver may control a logical stream's data flow via the serial data interface 306.

In some embodiments, the serial data receiver 324 receives messages (e.g., messages similar in form to those transmitted by the serial data transmitter 302). In these embodiments, headers of the received messages may be processed to extract the flow control information 326.

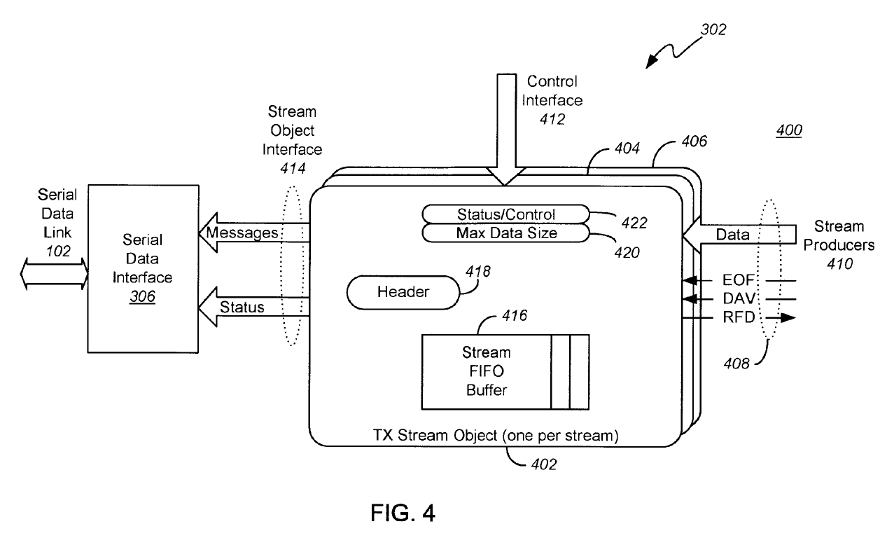

FIG. 4 illustrates an exemplary way of implementing the serial data transmitter 302 (FIG. 3) using a field-programmable gate array (FPGA 400). As shown, the serial data transmitter 302 may be provided with a transmit (TX) stream object 402, 404, 406 (i.e., an FPGA hardware block) per logical data stream 308, 310, 312. Each of the TX stream objects 402, 404, 406 is, in turn, provided: a logical data stream interface 408 to a stream producer 410; a control interface 412 to allow configuration of stream object parameters, and a message and status interface 414 between the stream object and the serial data interface 306.

Each of the TX stream objects 402, 404, 406 contains a FIFO buffer 416 to buffer (or stage) data received from its internal stream interface 408. Buffering or staging of data is needed to keep the serial data interface 306 free to transmit data for other streams.

When assembling a message, each TX stream object 402, 404, 406 prepends message data with a message header. This is done by the header block 418. In some embodiments, the data portion of a message may have a variable width, with the end of the message being determined by a “maximum data size” register 420 or a data word marked with an EOF indicator. The “maximum data size” register 420 may also be used to set a threshold for the FIFO buffer 416. That is, when the amount of data staged in the FIFO buffer 416 exceeds the maximum data size, data staged in the FIFO buffer 416 may be assembled into a message for transmission via the serial data interface 306. Note however, in some cases, data may accumulate in the FIFO buffer 416 fast enough that multiple messages can be formed from the data staged in the FIFO buffer 416. This is especially useful for consistently streaming data such as in-phase/quadrature (I/Q) sample data, where there is no data framing.

Via the logical data stream interface 408, a stream producer 410 may assert an EOF indicator to mark the end of a particular piece of data. In some embodiments, the EOF indicator signifies that a message shall terminate with the EOF indicator (typically early with respect to the maximum data size).

In some cases, the FIFO buffer 416 may contain multiple EOF indicators, each of which marks the end of a different piece of data. In other cases, multiple messages may be assembled and transmitted before the next EOF indicator is reached, or the data contained between EOF indicators may be less than what can be carried by a single message. The use of EOF indicators enables framed data, such as interprocess communication (IPC) or co-processor data, to be transmitted via the serial data interface 306. Periodically inserted EOF indicators may also be used to ‘bump’ (synchronize) streaming data, such as I/Q sample data, to ensure alignment between the serial data transmitter 302 and a remote receiver.

The Data Available (DAV) and Ready for Data (RFD) signals control when data is transferred from a stream producer 410 to a stream object 402. If both DAV and RFD are asserted, data is transferred to a TX stream object 402.

The control interface 412, in combination with the control/status logic 422 and maximum data size register 420, enables the read and configuration (write) of stream object parameters. The readable and configurable stream object parameters may comprise, for example: the maximum data size; a FIFO Empty indicator; a FIFO Full indicator; a FIFO data count; an option to flush/reset the FIFO buffer and message generation processes; a TX stream object enable; and a FIFO Empty indicator mask. A FIFO empty condition occurs when the FIFO data count transitions from non-zero to zero. When asserted, the FIFO Full indicator stalls the transfer of data from a stream producer 410 to a stream object 402. The FIFO data count reflects a count of data entries currently stored in the FIFO buffer 416. The FIFO Empty indicator mask is used to suppress assertion of the FIFO Empty indicator, and can be important when using a logical data stream to send bursted data such as IPC or co-processor data.

In some embodiments, the priority scheme for the logical data streams served by the stream objects 402, 404, 406 may be a “hard” priority scheme. For example, each stream object 402, 404, 406 may be associated with a priority number (e.g., 0, 1, 2 . . . N), with a lower numbered object having priority over a higher numbered object. Alternately, the priority scheme may be statically or dynamically configured via the control interface 412.

In the serial data transmitter 302 (FIG. 4), a data staging mechanism is provided, in part, by the plurality of FIFO buffers 416; a message generation mechanism is provided, in part, by the header generation logic 418 and the serial data interface 306; and an arbitration mechanism is provided, in part, by the control interface 412 and the serial data interface 306.

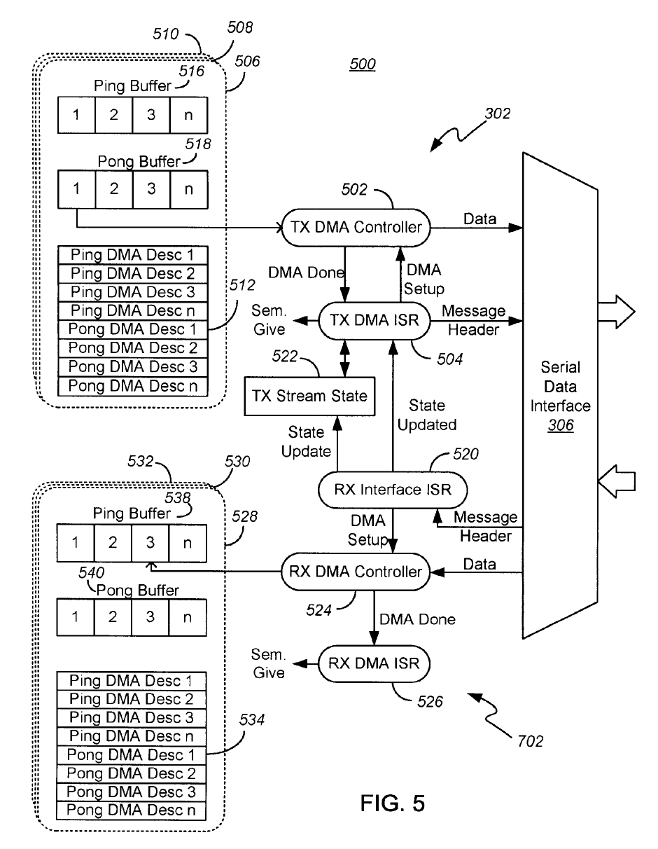

FIG. 5 illustrates an exemplary way of implementing the serial data transmitter 302 (FIG. 3) using a digital signal processor (DSP 500). The serial data transmitter 302 is provided with a TX DMA controller 502, a TX DMA interrupt service routine (ISR) 504, and one or more linked lists of direct memory access (DMA) structures 506 (or 508 or 510) per logical data stream. Each of the DMA structures 512 may be provided a separate DMA descriptor, and any other information needed for logical streaming (such as a ‘sem’ field for sending semaphores), thereby enabling each of the DMA structures 512 to be separately read from the linked list. In general, smaller DMA structures 512 facilitate the transmission of smaller messages via the serial data interface 306, which can help reduce instantaneous latency when multiple logical data streams need to transmit data via the serial data interface 306.

In some cases, a ping/pong buffer approach 516, 518 may be used to source or sink data. In these cases, each of the buffers 516, 518 may be associated with a linked list of DMA structures. This enables a central processing unit (CPU) to stage data in one buffer while the data staged in the other buffer is transmitted via the serial data interface 306.

FIG. 5 also illustrates an exemplary serial data receiver 702. The serial data receiver 702 will be described in more detail later in this description. However, for purposes of fully describing the serial data transmitter 302, it is noted that the serial data receiver 702 may receive flow control information via the serial data interface 306. The flow control information indicates a remote receiver's readiness to receive data, and preferably indicates the remote receiver's readiness to receive data corresponding to each of a plurality of logical data streams. In some embodiments, the flow control information is extracted from headers of received messages.

The flow control information received by the serial data receiver 702 is captured by a receive (RX) Interface ISR 520 and stored in a TX Stream State register 522. When flow control information is updated, the RX Interface ISR 520 notifies the TX DMA ISR 504, which then reads the TX Stream State register 522.

The TX DMA ISR 504 arbitrates access to the serial data interface 306. In this respect, the TX DMA ISR uses i) data readiness indicators for each of the logical data streams served by the transmitter 302, ii) a priority scheme of the logical data streams, and iii) the flow control information received from the remote receiver, to periodically designate an “active” one of the logical data streams. The TX DMA ISR 504 also assembles message headers and instructs the TX DMA controller 502 to retrieve data, as necessary, from the linked lists of DMA structures 506, 508, 510.

In some embodiments, the TX DMA ISR 504 is called when either 1) the current TX DMA transfer is completed, 2) flow control information is received, or 3) a data readiness indicator for one of the logical data streams has been updated. Because of these different circumstances for calling the TX DMA ISR 504, the TX DMA ISR 504 cannot assume that the TX DMA controller 502 is free (and must check before instructing the TX DMA controller 502 to take new actions).

The TX DMA ISR 504 may also provide stream semaphores. For example, upon the completion of a TX DMA transfer, and if the ‘sem’ field of the DMA descriptor is non-zero, a stream semaphore may be given to notify a stream owner task that data has been sent.

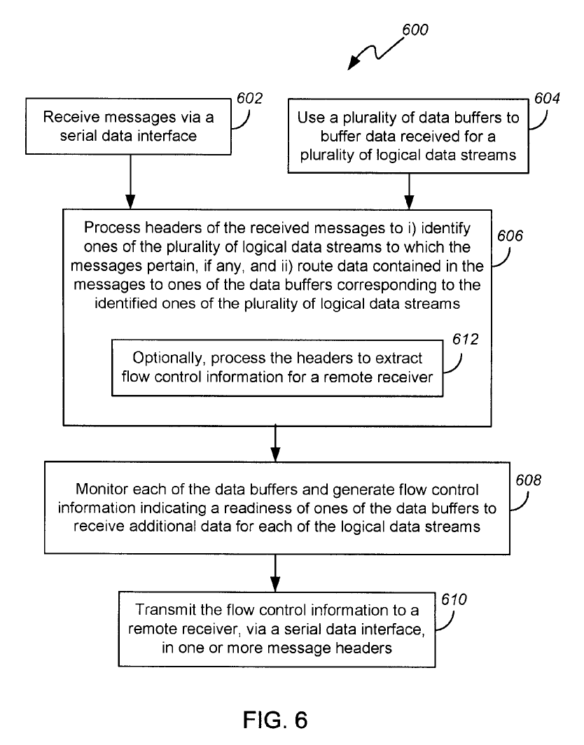

Having described an exemplary method 200 (FIG. 2) for transmitting data via a serial data interface 306 (and exemplary apparatus 300 for performing same; see FIG. 3), an exemplary method 600 (FIG. 6) for receiving data via a serial data interface will now be described. In some embodiments, the method 600 for receiving data may be combined with the method 200 for transmitting data, with the combined method being performed, for example, by a single one of the devices 104, 106 shown in FIG. 1.

At step 602 of the method 600, messages are received via a serial data interface. At step 604, a plurality of data buffers are used to buffer data received for a plurality of logical data streams. At step 606, headers of the received messages are processed to i) identify ones of the plurality of logical data streams to which the messages pertain, if any, and ii) route data contained in the messages to ones of the data buffers corresponding to the identified ones of the plurality of logical data streams. Optionally, at step 612, the headers of the received messages may also be processed to extract flow control information, which flow control information may be used by a corresponding data transmission method (e.g., method 200, FIG. 2).

At step 608 of the method 600, each of the data buffers is monitored, and flow control information is generated. The flow control information indicates the readiness of ones of the data buffers to receive additional data for the logical data streams. At step 610, the flow control information is transmitted to a remote receiver. In some embodiments, the flow control information is transmitted to the remote receiver in one or more message headers, which headers may be similar to (or the same as) the headers processed in step 606 of the method 600.

Although the steps of the method 600 are shown to have a particular flow, it is noted that the flow is not important, and that various flows are contemplated. In fact, in most cases, all of the method's steps will be performed in parallel. The method's steps may also be performed in parallel with the method steps shown in FIG. 2.

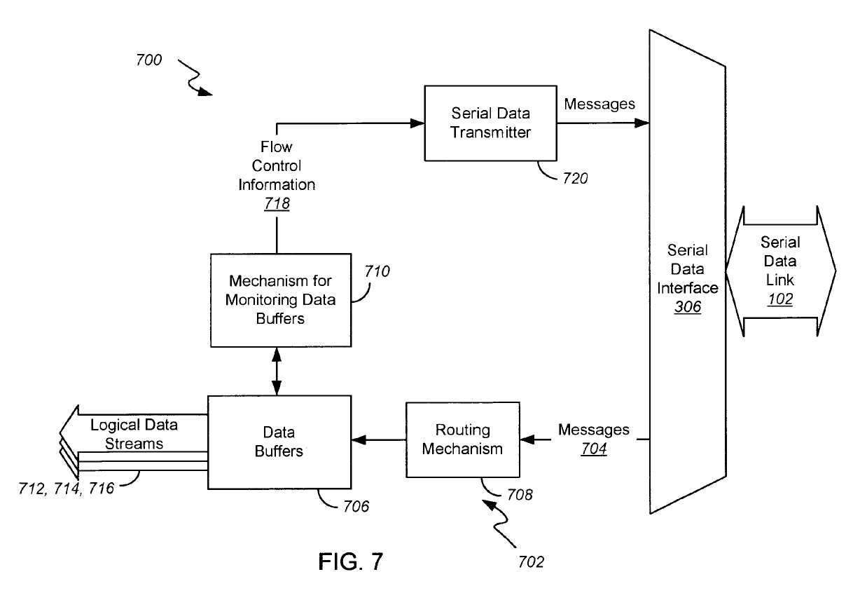

FIG. 7 illustrates exemplary apparatus 700 for implementing a method such as the method 600. As shown, the apparatus 700 comprises a serial data receiver 702 that is configured to receive messages 704 via a serial data interface 306. The serial data receiver 702 comprises a plurality of data buffers 706, a message router 708, and a mechanism 710 for monitoring each of the data buffers 706. In some embodiments, these structures may be implemented individually. In other embodiments, the functionality of these structures may be provided by one or more multi-purpose structures.

The plurality of data buffers 706 buffer data received for a plurality of logical data streams 712, 714, 716. The message router 708 i) processes headers of the messages received via the serial data interface to identify ones of a plurality of logical data streams 712, 714, 716 to which the messages pertain, and ii) routes data contained in the messages to ones of the data buffers 706 corresponding to the identified ones of the logical data streams 712, 714, 716. The mechanism 710 for monitoring each of the data buffers 706 not only monitors the data buffers 706, but also generates flow control information 718 indicating the readiness of the serial data receiver 702 to receive additional data. Preferably, the flow control information 718 indicates the readiness to receive additional data for each logical data streams 712, 714, 716.

In some embodiments, the apparatus 700 shown in FIG. 7 may further comprise a serial data transmitter 720. The serial data transmitter may be configured to transmit the flow control information 718 generated by the mechanism 710 to a remote receiver. In some embodiments, the serial data transmitter 720 may transmit the flow control information 718 in (or as part of) one or more message headers. When the serial data transmitter 720 is used to transmit messages carrying data corresponding to a second plurality of logical data streams (such as the logical data streams 308, 310, 312 shown in FIG. 3), the flow control information 718 may be transmitted in the headers of one or more of these messages. Alternately, or when none of the second logical data streams 308, 310, 312 have data for transmission, the flow control information 718 may be transmitted via one or more header-only messages (i.e., a message that does not carry any of the data staged for the second plurality of logical data streams 308, 310, 312).

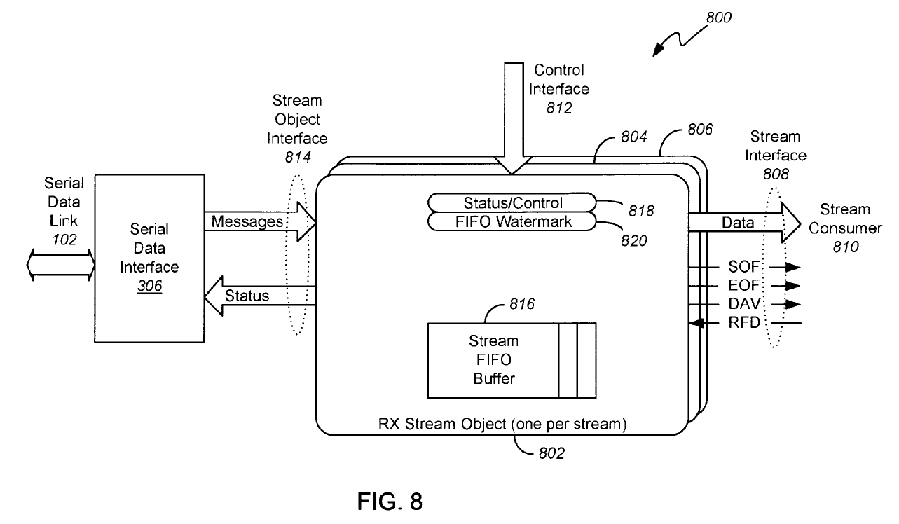

FIG. 8 illustrates an exemplary way of implementing the serial data receiver 702 (FIG. 7) using a field-programmable gate array (FPGA 800). The serial data receiver 702 is provided with a receive (RX) stream object 802, 804, 806 (i.e., an FPGA hardware block) per logical data stream. Each of the RX stream objects 802, 804, 806 is provided with: a logical data stream interface 808 to a stream consumer 810; a control interface 812 to allow configuration of stream object parameters; and a message and status interface 814 between the stream object and the serial data interface 306.

As messages are received, the serial data interface 306 reads and discards each message header before routing the data contained in a message to the logical data stream (or RX receive object 802, 804, 806) to which it pertains. The serial data interface 306 may also extract flow control information from some or all of the message headers, which flow control information may be forwarded to the arbitration mechanism 318 (FIG. 3) of a corresponding serial data transmitter 302.

Each of the RX stream objects 802, 804, 806 contains a FIFO buffer 816 to buffer the data it receives from the serial data interface 306. Buffering of data is needed to keep the serial data interface 306 free to receive data for other streams.

The Data Available (DAV) and Ready for Data (RFD) signals control when data is transferred from a stream object 802 to a stream consumer 810. If both DAV and RFD are asserted, data is transferred from a RX stream object 802. A stream object 802 may also support Start of Frame (SOF) and End of Frame (EOF) signals, which signals may be generated in response to received messages being marked with SOF and EOF indicators.

The control interface 812, in combination with the control/status logic 818 and FIFO watermark register 820, enables the read and configuration (write) of stream object parameters. The readable and configurable stream object parameters may comprise, for example: a FIFO Watermark level; a FIFO Empty indicator; a FIFO Overflow indicator; a FIFO data count; an option to flush/reset the FIFO buffer; a RX stream object enable; and a FIFO Empty indicator mask. A FIFO empty condition occurs when the FIFO data count transitions from non-zero to zero. The FIFO Overflow condition occurs when a write to the FIFO buffer is attempted while the FIFO is full. The FIFO data count reflects a count of data entries currently stored in the FIFO buffer. The FIFO Empty indicator mask is used to suppress the FIFO Empty indicator, and can be important when using a logical data stream to receive non-contiguous or sparse data, such as IPC or co-processor data.

Flow control information for a stream object 802 may be generated by comparing a stream object's FIFO data count to the stream object's FIFO Watermark level. If the FIFO data count exceeds the FIFO Watermark level (i.e., a FIFO buffer 816 holds data in excess of its watermark level), the readiness status of the stream object may be changed from “ready” to “not ready”. If the serial data receiver 702 is coupled to a serial data transmitter, the serial data transmitter may transmit the serial data receiver's flow control information to a remote receiver, thereby causing a remote transmitter to stop or slow the transmission of data corresponding to one or more logical data streams. In some embodiments, a serial data receiver's flow control information is only transmitted (or published) to a remote receiver upon the occurrence of predetermined events, such as: 1) when the FIFO data count transitioning from above to below the FIFO Watermark level; 2) when the last piece of data in a message is written to a RX stream object and the object's FIFO data count remains below the watermark level; 3) when a FIFO Overflow condition occurs; or 4) when a FIFO Empty condition occurs and the FIFO Empty indicator mask is not set. In other embodiments, flow control information can be sent upon the occurrence of other events, or on a periodic basis. Preferably, the flow control information is incorporated into the headers of transmitted messages; and when possible, the flow control information is incorporated into the headers of messages carrying data for logical data streams. However, when no logical data stream has data to send, the flow control information may, in some embodiments, be incorporated into a header-only message, as previously discussed.

In the serial data receiver 702 (FIG. 8), a plurality of data buffers is provided, in part, by the plurality of FIFO buffers 816; a message router is provided, in part, by the serial data interface 306; and a mechanism for monitoring each of the data buffers is provided, in part, by the control interface 812 and the serial data interface 306.

FIG. 5 illustrates an exemplary way of implementing the serial data receiver 702 using a DSP 500. The serial data receiver 702 is provided with a RX DMA controller 524, a RX Interface ISR 520, a RX DMA ISR 526, and one or more linked lists of direct memory access (DMA) structures 528, 530, 532 per logical data stream. Each of the DMA structures 534 may be provided a separate DMA descriptor, and any other information needed for logical streaming (such as a ‘sem’ field for sending semaphores), thereby enabling each of the DMA structures 534 to be separately written.

In some cases, a ping/pong buffer approach 538, 540 may be used to source or sink data. In these cases, each of the buffers 538, 540 may be associated with a linked list of DMA structures. This enables a central processing unit (CPU) to read data from one buffer while data received via the serial data interface is written to the other buffer.

The RX Interface ISR 520 strips the header from each incoming message, and determines where to DMA the data content of the message based on the RX DMA descriptors for the linked lists of DMA structures 528, 530, 532. Preferably, message headers themselves are not written into the DMA structures 534, thereby enabling the storage of contiguous data records. Upon completing the write of a message's data content, a semaphore may be provided by the RX DMA ISR 526. For example, upon the completion of a RX DMA transfer, and if the ‘sem’ field of the DMA descriptor is non-zero, a stream semaphore may be given to notify a stream owner task that a data record has been completely captured.

FIG. 5 also illustrates an exemplary serial data transmitter 302, as previously discussed. If the serial data receiver 702 receives flow control information via the serial data interface 306, the flow control information may be captured by the RX interface ISR 520 and transferred to the TX DMA ISR 504, for processing as previously described.

As previously mentioned, the system 100 (FIG. 1), in combination with the various transmitters and receivers disclosed herein, enables the transmission of data corresponding to multiple logical data streams over a single serial data link. In addition, the system 100 enables the data in each logical data stream to be transmitted in a manner that is largely independent of what is occurring with other logical data streams (subject to the priority scheme of the logical data streams). Still further, when each of the stream interfaces 112, 114 of the system 100 is configured to transmit and receive flow control information, the transmission of data corresponding to a particular data stream may be regulated by both the transmitting and receiving ends of the system 100.

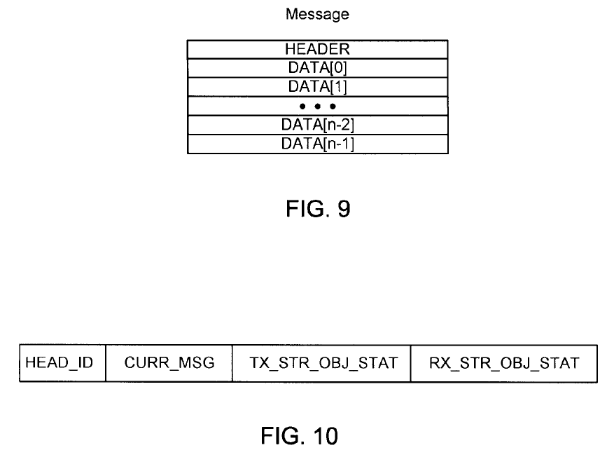

The serial data link shown in FIG. 1 may be implemented using various serial data link protocols, including the Link-Port protocol of the TigerSHARC® processor, the Aurora serial connectivity protocol (developed by Xilinx, Inc. of San Jose, Calif., USA), and various low-voltage differential signaling (LVDS) protocols. In a Link-Port environment, each message transmitted over the serial data link comprises a group of contiguous quad words, including a single quad word header followed by a block of [0 . . . n] quad words of raw data. See FIG. 9 for an exemplary Link-Port message structure (although this message structure can also be used for other serial data link protocols). In the event the number of data blocks equals zero, the message only includes a header (i.e., it is a header-only message).

Of note, the message structure of the Link-Port protocol anticipates quad-words of 128 bits. However, the transmitters and receivers disclosed herein may be configured to pack data of different widths (e.g., 32-bit, 64-bit or 128-bit widths) into each Link-Port quad word. Furthermore, and in the event that the end of a raw data block does not fall on a quad word boundary, the last transmitted quad word may be padded with a predetermined fill pattern.

In a Link-Port environment, the first device shown in FIG. 1 may be a TigerSHARC® processor, configured to implement the serial data transmitter and serial data receiver shown in FIG. 5. The second device shown in FIG. 1 may be an FPGA, configured to implement the serial data transmitter and serial data receiver shown in FIGS. 4 and 8.

FIG. 10 illustrates an exemplary configuration of a message header, which header may be used by various serial data link protocols, and in particular, the Link-Port protocol. The header includes a header identifier portion (HEAD_ID), a current message identifier portion (CURR_MSG), a transmit stream status portion (TX_STR_OBJ_STAT), and a receive stream status portion (RX_STR_OBJ_STAT).

The header identifier is a unique string of bits that identifies the start of a header to a receiver. However, in a Link-Port environment, the HEAD_ID portion of the header may also be used by an FPGA to report an error condition, or used by a TigerSHARC® to clear an error condition.

The current message identifier identifies the logical data stream to which a message pertains. In one embodiment, a bit may be provided for each of a plurality of logical data streams, and one of the bits may be set to identify the logical data stream to which a message pertains. Alternately, multiple ones of the bits could be set, to “multicast” a message to more than one of the logical data streams. If a message consists of nothing more than a header, all bits may be cleared.

In a Link-Port environment, the transmit stream status portion of the header may indicate 1) serial data transmitter errors per logical data stream (in FPGA→TigerSHARC transmissions), or 2) whether stream errors should be cleared per logical data stream (in TigerSHARC→FPGA transmissions).

Also in a Link-Port environment, the receive stream status portion of the header may indicate the readiness of a serial data receiver to receive data corresponding to each logical data stream. In addition, the receive stream status portion of the header may indicate 1) serial data receiver errors per logical data stream (in FPGA→TigerSHARC transmissions), or 2) whether stream errors should be cleared per logical data stream (in TigerSHARC→FPGA transmissions).

What is claimed is:

1. A method for transmitting data corresponding to each of a plurality of logical data streams via a serial data interface, comprising:
staging data for at least some of the logical data streams;
determining a data readiness of the data staged for each logical data stream;
generating a plurality of messages, each of the messages having a header, and at least some of the messages carrying some of the data, wherein the headers of the messages carrying data identify the logical data stream(s) to which their data pertains;
using i) the data readiness of the data staged for each logical data stream, and ii) a priority scheme of the logical data streams, to periodically designate an active one of the logical data streams; and
transmitting, via the serial data interface, messages corresponding to the active one of the plurality of logical data streams, but not messages corresponding to other ones of the plurality of logical data streams.

2. The method of claim 1, further comprising:
receiving flow control information via the serial data interface, the flow control information indicating a remote receiver's readiness to receive data; and
also using the flow control information to periodically designate the active one of the logical data streams.

3. The method of claim 2, further comprising:
receiving messages via the serial data interface; and
processing headers of the received messages to extract the flow control information.

4. The method of claim 1, further comprising:
receiving messages via the serial data interface;
using a plurality of data buffers to buffer data received for a second plurality of logical data streams;
processing headers of the received messages to i) identify ones of the second plurality of logical data streams to which the messages pertain, if any, and ii) route data contained in the messages to ones of the data buffers corresponding to the identified ones of the second plurality of logical data streams;
monitoring each of the data buffers and generating flow control information indicating a readiness of ones of the data buffers to receive additional data for each of the second logical data streams; and
transmitting the flow control information to the remote receiver, via the serial data interface, in one or more of the headers of the messages.

5. The method of claim 4, further comprising, transmitting, via the serial data interface, messages having headers only, the header-only messages carrying at least some of the flow control information but none of the staged data.

6. Apparatus, comprising:
a serial data transmitter configured for transmitting, via a serial data interface, messages corresponding to an active one of a plurality of logical data streams, but not messages corresponding to other ones of the plurality of logical data streams, the serial data transmitter having,
a data staging mechanism for staging data for at least some of the logical data streams, and for setting a data readiness indicator for the data staged for each of the logical data streams;
a message generation mechanism for generating a plurality of messages, each of the messages having a header, and at least some of the messages carrying some of the data, wherein the headers of the messages carrying data identify the logical data stream(s) to which their data pertains; and
an arbitration mechanism that uses i) the data readiness indicators for the logical data streams, and ii) a priority scheme of the logical data streams, to periodically designate the active one of the logical data streams.

7. The apparatus of claim 6, wherein the data staging mechanism comprises a plurality of FIFO buffers.

8. The apparatus of claim 6, wherein the data staging mechanism comprises a plurality of ping/pong buffers, wherein the data staging mechanism alternately stages data in the ping buffer or the pong buffer of each set of ping/pong buffers.

9. The apparatus of claim 6, further comprising:
a serial data receiver configured for receiving flow control information via the serial data interface, the flow control information indicating a remote receiver's readiness to receive data;
wherein the arbitration mechanism further uses the flow control information to periodically designate the active one of the logical data streams.

10. The apparatus of claim 9, wherein the flow control information indicates a remote receiver's readiness to receive data corresponding to each of the plurality of logical data streams.

11. The apparatus of claim 9, wherein the serial data receiver and the serial data transmitter are implemented using a digital signal processor.

12. The apparatus of claim 6, further comprising:
a serial data receiver configured for receiving messages via the serial data interface, the serial data receiver having,
a plurality of data buffers for buffering data received for a second plurality of logical data streams;
a message router for i) processing headers of the messages received via the serial data interface to identify ones of the second plurality of logical data streams to which the messages pertain, if any, and ii) routing data contained in the messages to ones of the data buffers corresponding to the identified ones of the second plurality of logical data streams; and
a mechanism for monitoring each of the data buffers and generating flow control information indicating the readiness of the serial data receiver to receive additional data for each of the second logical data streams;
wherein the serial data transmitter is further configured for transmitting the flow control information to the remote receiver, in one or more of the headers of the messages.

13. The apparatus of claim 12, wherein the serial data transmitter is further configured for transmitting, via the serial data interface, messages having headers only, the header-only messages carrying at least some of the flow control information but none of the staged data.

14. The apparatus of claim 6, wherein the serial data transmitter is implemented using a field-programmable gate array.

15. The apparatus of claim 6, wherein the data readiness indicator for a particular logical data stream is set to indicate that the particular logical data stream is ready to transmit, in part, when i) the staging mechanism has staged more than a predetermined quantity of data for the particular logical data stream, or ii) an end-of-frame indicator is received for the particular logical data stream.

16. The apparatus of claim 6, wherein the message generation mechanism provides at least some of the messages with headers that indicate the messages pertain to more than one of the logical data streams.

17. Apparatus, comprising:
a serial data receiver configured for receiving messages via a serial data interface, the serial data receiver having,
a plurality of data buffers for buffering data received for a plurality of logical data streams;
a message router for i) processing headers of the messages received via the serial data interface to identify ones of a plurality of logical data streams to which the messages pertain, if any, and ii) routing data contained in the messages to ones of the data buffers corresponding to the identified ones of the logical data streams; and
a mechanism for monitoring each of the data buffers and generating flow control information indicating a readiness of the serial data receiver to receive additional data; and
a serial data transmitter configured for transmitting the flow control information to a remote receiver.

18. The apparatus of claim 17, wherein the flow control information indicates a readiness to receive additional data for each logical data stream.

19. The apparatus of claim 17, wherein:
at least one of the data buffers is associated with a corresponding watermark level; and
the mechanism for monitoring each of the data buffers generates the flow control information, in part, based on one of the data buffers holding data in excess of its watermark level.

20. The apparatus of claim 19, further comprising a control interface for configuring at least one of the watermark levels.

21. The apparatus of claim 17, wherein the flow control information is only transmitted upon occurrences of predetermined events.
